(19) United States
(12) Patent Application Publication
(10) Pub. No.: US 2011/0153227 A1
(43) Pub. Date: Jun. 23, 2011

(54) Method and Device for Automatically Determining a Substance Based on Spectroscopic Examinations

(76) Inventor: Petra Perner, Leipzig (DE)

(21) Appl. No.: 12/977,783

(22) Filed: Dec. 23, 2010

(30) Foreign Application Priority Data
Dec. 23, 2009 (DE) 10 2009 060 925.3

(51) Int. Cl. G06F 19/00; G01N 31/00

(52) U.S. Cl. 702/28

(57) ABSTRACT

In a method for automatic substance determination based on spectroscopic examinations of unknown substances in comparison to known test substances, digital data sets are determined by a delta modulator from spectra of known test substances and saved as prototypes in a database. Digital data sets of the unknown substances are determined from spectra by the delta modulator and are sequentially compared with the digital data sets of the prototypes of the database by a comparator. For a positive result of comparing, the unknown substances are allocated to a respective prototype as a determined case in the database. For a negative result of comparing, the unknown substances are allocated to undetermined cases of the database. The delta modulator, the database, the comparator, and the allocator are components of a data processing system and are linked and interconnected in accordance with the sequence of the method steps.

### BACKGROUND OF THE INVENTION

The invention relates to methods and devices for automatic substance determination based on spectroscopic examinations of unknown substances in comparison to known substances in the form of test substances. The invention further relates to computer programs with a program code and computer program products on a machine-readable (computer-readable) carrier, each for performing the method for automatic substance determination based on spectroscopic examinations of unknown substances in comparison to known substances in the form of test substances.

The determination of substances and their properties by means of spectroscopy is known. The spectral data obtained by spectroscopy are saved in a suitable medium and are displayed for evaluation on data viewing devices. In this way, the data can be manually evaluated.

Such spectra are Raman spectra, spectra of mass-spectroscopy examinations, line spectra, in particular light spectra or x-ray spectra, or electron spectroscopy-based spectra. The devices employed for the purpose of spectroscopic examinations are known.

### SUMMARY OF THE INVENTION

It is an object of the present invention to determine automatically and in a simple way unknown substances by means of spectroscopic examinations.

In accordance with the present invention, this is achieved in that the method for substance determination based on spectroscopic examinations of unknown substances in comparison to known substances in the form of test substances is characterized by the following steps carried out in a data processing system (computer):
digital data sets are determined by means of a delta modulator from the spectra of the known substances;
the data sets of the known substances are saved as prototypes of determined spectra in a database;
digital data sets of the unknown substances of the spectra determined by spectroscopy are determined by means of the delta modulator;
the digital data sets of the unknown substances are sequentially compared with those of the prototypes of the database by means of a comparator;
wherein in case of a positive result of the comparison the unknown substances are allocated to the respective prototype as a determined (identified) case in the database; and
wherein in case of a negative result of the comparison the unknown substances are allocated to undetermined (unidentified) cases of the database.

The method is characterized in that unknown substances are automatically determined from the spectra in an easy process.

The device according to the present invention for substance determination based on spectroscopic examinations of unknown substances in comparison to known substances in the form of test substances, for performing the method as set out above, comprises a data processing system (computer) having embodied therein:
a delta modulator for determining the digital data sets of the spectra of the known substances as well as of digital data sets of the unknown substances of the spectra determined by spectroscopy;
a database for saving the data sets of the known substances as prototypes of determined spectra;
a comparator for sequential comparison of the digital data sets of the unknown substances with those of the prototypes of the database; and
a device (allocator) for allocating the unknown substances to the respective prototype as a determined (identified) case in the database in case of a positive result of the comparison and for allocating the unknown substances to undetermined (unidentified) cases of the database in case of a negative result of the comparison are realized and linked with each other;
wherein the delta modulator, the database, the comparator, and the device for allocating are linked and interconnected sequentially to each other.

The database, the delta modulator, the comparator, and the device for allocating are components (e.g. processors) of the data processing system (computer) and accordingly are connected to each other for interaction in accordance with the sequence of steps.

In this way, the method and the device are in particular suitable for evaluation of Raman spectroscopic examinations. Raman spectroscopy is the spectroscopic examination of inelastic scattering of light on molecules or solids. It serves inter alia for examining material properties. For this purpose, the substance to be examined is irradiated with monochromic tight of a laser. In the spectrum of the light scattered on the substance, in addition to the input frequency, also further frequencies are observed. Based on the obtained spectrum condusions in regard to the examined substance can be derived.

The basis is an interaction of the light with the substance, the so-called Raman effect where energy is transferred from the light onto the substance or energy from the substance is transmitted onto the light. Since the wavelength of the light depends on the energy of the light, this energy transfer has the effect of a shift of the wavelength of the scattered relative to the impinging light, the so-called Raman shift.

Based on the spectrum it is therefore possible to arrive at conclusions in regard to the properties of the substances.

In addition to evaluation of Raman spectra, the method and device according to the invention are also suitable for evaluation of the spectra of mass-spectroscopic examination. Moreover, of course, also line spectra, in particular based on light or x-ray spectroscopy, or spectra based on electron spectroscopy can be evaluated.

Digital data sets are determined from the spectra by means of a delta modulator. The delta modulator does not code the complete course of the spectrum but only the change within the spectrum. This change is formed based on the difference of the actual value in the spectrum to an estimated value that is provided by a coder. Encoded is only the direction of change. When the value in the spectrum is greater than the estimated value, the difference is positive. This value is allocated the binary value 1. When the value in the spectrum is smaller than the estimated value, the difference is negative. This value is allocated the binary value 0. In this way, a data set is obtained that corresponds to the course of the spectrum. The step size between the values can be predetermined as a constant value but it may also be changeable or variable. The estimated value is the result of preceding value and difference taking into account the sign. Accordingly, the result is advanced. This error is either negligible or, upon change of the binary value, can be corrected in that the binary value is adjusted before the change.

By using the delta modulator advantageously the curve of the spectrum is smoothed and noise is filtered out.

In this way a simple method and a simple device for substance determination from spectroscopic examinations of unknown substances are provided. The comparison is reduced to the sequential comparison of digital data sets.

Advantageously, the method is also available as a computer program with a program code and as a computer program product on a machine-readable (computer-readable) carrier for performing the method for automatic substance determination based on spectroscopic examinations of unknown substances in comparison to known substances in the form of test substances.

Advantageous embodiments of the invention are disclosed in the dependant claims.

According to one embodiment of the method, features of the spectra of unknown substances are determined. The features are allocated furthermore to the prototypes and are saved in the database. Moreover, the prototype is assigned a name and/or code, for example, as an index.

In addition to the data sets the prototypes also include the features of the respective spectra.

In a further modification of the method of the present invention, the features of the unknown substance of the case that is not determined by the data set are determined. Moreover, the similarity between features of the prototype and features of the undetermined case are calculated wherein during the calculation of the similarity the similarity parameters, either as distance values or as similarity values, are determined until either a minimum of the distance values or a maximum of the similarity values is present.

In connection with the data processing system, additional components are realized or provided in this context:

a device for determining features of the spectra; and

a device for calculating the similarity between features of the spectra of the prototypes and features of the spectrum of the undetermined case;

wherein these components are appropriately linked and interconnected with each other.

The features of the spectra of the known substances are then allocated to the respective prototype.

In a further development of the invention, the similarity parameters determine the allocation to at least one prototype.

In this connection, also an allocation to several prototypes may be realized that are advantageously visually displayed or represented by means of a display (monitor or screen) that is connected to the data processing system. In this way, the manual allocation or disposal can be realized. The latter can also lead to a new prototype.

Advantageously, according to another aspect of the invention, the features are the position, the height and/or the width of the peaks of the course of the curve of the spectrum.

The delta modulator according to another embodiment of the invention is a linear delta modulator or an adaptive delta modulator wherein the latter in particular is a momentary value compander.

In comparison to the linear delta modulator the adaptive delta modulator has a functional block that takes over the control of the step size in accordance with the course of the spectrum.

In this connection, the momentary value compander changes its step size any time. For this purpose, an adaption logic circuit decides at the input sequence with which factor the preceding step size is to be multiplied.

### BRIEF DESCRIPTION OF THE DRAWING

FIG. 1 shows schematically a device for automatic substance determination based on Raman spectroscopic examinations of unknown substances in comparison to known substances in the form of test substances by means of data sets.

FIG. 2 shows a device with similarity determination of Raman spectra.

### DESCRIPTION OF THE PREFERRED EMBODIMENTS

The following embodiment explains in more detail jointly a method and a device for automatic substance determination of Raman-spectroscopic examinations of unknown substances in comparison to known substances in the form of test substances.

A device for substance determination based on Raman spectroscopic examinations of unknown substances in comparison to known substances in the form of test substances is comprised substantially of a data processing system (computer) with a delta modulator 2, a database 3, a comparator 4, and an allocating device 5.

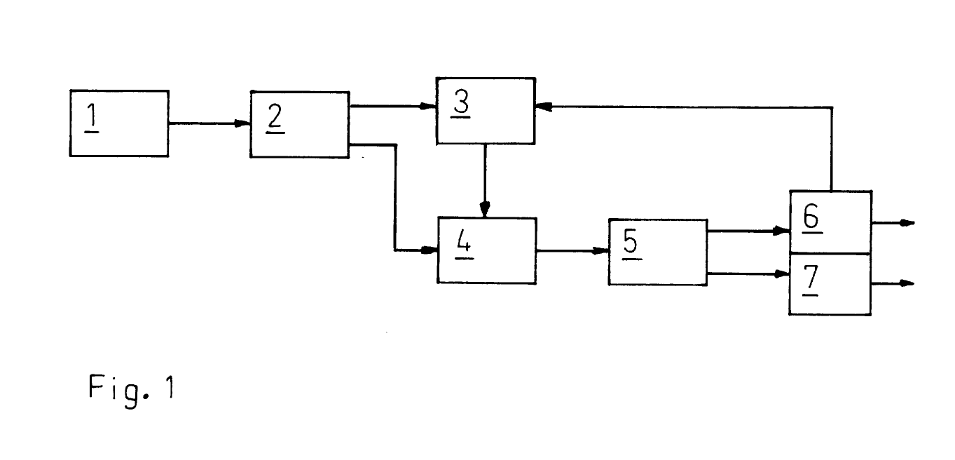

FIG. 1 shows in a basic illustration a device for automatic substance determination from Raman-spectroscopic examinations of unknown substances in comparison to known substances in the form of test substances by means of data sets.

In the data processing system (computer) digital data sets are determined by means of the delta modulator 2 based on Raman spectra 1 of known substances. These data sets of the known substances are saved as prototypes of determined Raman spectra in the database 3. The prototypes have assigned names and/or codes, in particular as indices. This database 3 is the basis for determination of unknown substances.

For the determination of unknown substances based on the respective Raman spectra 1 a data set is determined by means of the delta modulator 2. This data set is compared sequentially with data sets of the prototypes of the database 3. For this purpose, an appropriately designed comparator 4 is employed. Upon positive result of comparison, an allocation of the unknown substance to the prototype as a determined case 6 in the database 3 is carried out. The unknown substance is thus determinable by the correlated prototype. In case of a negative result of comparison, an allocation or correlation of the unknown substance to undetermined or unidentified cases 7 in the database 3 is carried out.

Accordingly, in case of a positive result of comparison of the data sets a quick allocation or correlation of on undetermined (unidentified) substances to prototypes is provided. By means of the prototypes the substances that are not determined or identified are thus determined. The individual cases may also be displayed on at least one screen (display, monitor) connected with the data processing system.

In one embodiment of the illustrated device, the Raman spectra of unknown substances that, after a negative result of comparison, are assigned to the undetermined cases 7 are further compared with the prototypes.

As a basis for this purpose, features of the Raman spectra of the known substances are determined. They are then assigned to or correlated with the respective prototype and saved in the database 3. Moreover, the respective prototype is assigned a name and/or a code.

Features are e.g. the position, the height and/or the width of the peaks of the respective Raman spectrum.

Moreover, the features of the unknown substance of the respective unknown case 7 are determined and the similarity between the features of the prototype and the features of the undetermined or unidentified case 7 are calculated. In this connection, during calculation of the similarity, the similarity parameters are determined, either as distance values or similarity values, until either a minimum of the distance values or a maximum of the similarity values is present.

For this purpose, in the data processing system there are moreover realized or provided the following components: a device 8 for determining features of the Raman spectra 1 and a device 9 for calculating the similarity, wherein these components (processors) are linked and interconnected with each other.

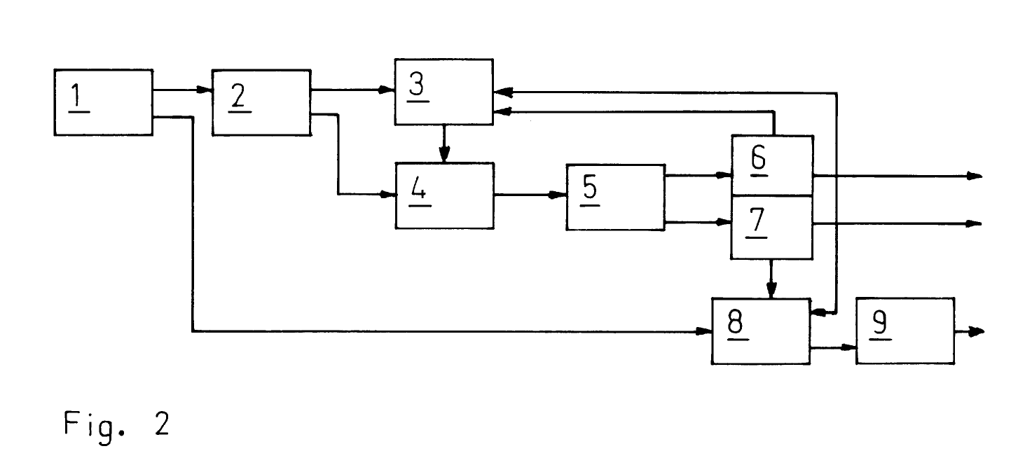

FIG. 2 shows a device with a similarity determination of Raman spectra in a basic illustration.

The determined similarity parameters determine the assignment or correlation of the undetermined case 7 to at least one of the prototypes.

Advantageously, a data display device in the form of a monitor or screen is connected to the data processing system (computer) so that Raman spectra can be visually displayed. In this way, a control and/or assignment of the Raman spectrum can be carried out. This is advantageous in particular for new prototypes, the determined or identified cases 6, and the undetermined or unidentified cases 7.

A further embodiment is a computer program with a program code for performing the method for automatic substance determination of Raman-spectroscopic examinations of unknown substances in comparison to known substances in the form of test substances in accordance with the inventive method when the program is running on a computer.

A computer program product on a machine-readable (computer-readable) carrier for performing the method for automatic substance termination of Raman-spectroscopic examinations of unknown substances in comparison to known substances in the form of test substances in accordance with the inventive method when the program is running on a computer is a further embodiment.

The specification incorporates by reference the entire disclosure of German priority document 10 2009 060 925.3 having a filing date of Dec. 23, 2009.

While specific embodiments of the invention have been shown and described in detail to illustrate the inventive principles, it will be understood that the invention may be embodied otherwise without departing from such principles.

What is claimed is:

1. A method for automatic substance determination based on spectroscopic examinations of unknown substances in comparison to known test substances, the method comprising:
determining by a delta modulator digital data sets from spectra of the known test substances;
saving in a database the data sets of the known test substances as prototypes of determined spectra;
determining by the delta modulator digital data sets of the unknown substances from spectra determined by spectroscopy;
sequentially comparing by a comparator the digital data sets of the unknown substances with the digital data sets of the prototypes of the database;
for a positive result of the step of comparing, allocating by an allocator the unknown substances to a respective prototype as a determined case in the database;
for a negative result of the step of comparing, allocating by the allocator the unknown substances to undetermined cases of the database;
wherein the delta modulator, the database, the comparator, and the allocator are components of a data processing system and are linked and interconnected in accordance with the sequence of the method steps.

2. The method according to claim 1, further comprising determining features of the spectra of the known test substances, assigning the features to the prototypes and saving the features in the database, and assigning a name and/or a code to the prototypes.

3. The method according to claim 2, further comprising determining the features of the unknown substance of the undetermined case and calculating a similarity between the features of the prototype and the features of the undetermined case, wherein during the step of calculating similarity parameters are determined either as distance values or similarity values until either a minimum of the distance values or a maximum of the similarity values is present.

4. The method according to claim 3, wherein the similarity parameters determine assignment to at least one prototype.

5. The method according to claim 3, wherein the features are a position, a height and/or a width of peaks of the spectra.

6. The method according to claim 2, wherein the features are a position, a height and/or a width of peaks of the spectra.

7. The method according to claim 1, wherein the delta modulator is a linear delta modulator or an adaptive delta modulator.

8. The method according to claim 7, wherein the adaptive delta modulator is a momentary value compander.

9. A device for automatic substance determination based spectroscopic examinations of unknown substances in comparison to known test substances with a data processing system for performing the method according to claim 1, wherein the data processing system comprises:
a delta modulator for determining digital data sets of spectra of known test substances as well as of digital data sets of unknown substances based on the spectra determined by spectroscopy;
a database for saving the data sets of the known test substances as prototypes of determined spectra;
a comparator for sequential comparison of the digital data sets of the unknown substances with the prototypes of the database; and
an allocator for allocating the unknown substances to a respective prototype as a determined case in the database in case of a positive result of the comparison and for allocating the unknown substances to undetermined cases of the database in case of a negative result of the comparison;
wherein the delta modulator, the database, the comparator, and the allocator are sequentially linked and interconnected with each other.

10. The device according to claim 7, wherein the data processing system further comprises a device for determining features of the spectra and a device for calculating a similarity between features of the spectra of the prototypes and features of the spectra of the undetermined case, wherein, during calculating the similarity, similarity parameters are determined either as distance values or similarity values until either a minimum of the distance values or a maximum of the similarity values is present, wherein the device for determining features and the device for calculating similarity are linked and interconnected with each other.

11. A computer program with a program code for performing the method according to claim 1 for automatic substance determination of spectroscopic examinations of unknown substances in comparison to known test substances, when the program is running on a computer.

12. A computer program product on a machine-readable (computer-readable) carrier for performing the method according to claim 1 for automatic substance determination of spectroscopic examinations of unknown substances in comparison to known test substances, when the program is running on a computer.
